(19) United States
(12) Patent Application Publication
(10) Pub. No.: US 2025/0259037 A1
(43) Pub. Date: Aug. 14, 2025

(54) GRAPH NEURAL NETWORK TRAINING USING USER SKILLS

(71) Applicant: Microsoft Technology Licensing, LLC, Redmond, WA (US)

(72) Inventors: Zhujun Chen, Belmont, CA (US); Ping Liu, Weston, FL (US); Xiaochen Hou, Sunnyvale, CA (US); Qianqi Shen, Saratoga, CA (US)

(21) Appl. No.: 18/441,949

(22) Filed: Feb. 14, 2024

(51) Int. Cl. G06N 3/0455

(52) U.S. Cl. CPC G06N 3/0455

(57) ABSTRACT

Methods, systems, and apparatuses include training a graph neural network. Content items are received for a user of an online system, the content items including skills. An input graph is generated using the content items, the input graph including nodes and edges linking the nodes. The input graph is sampled using a source node and skills to generate a first computational graph. The input graph is sampled using a target node and skills to generate a second computational graph. A source node embedding is generated by encoding the first computational graph. A target node embedding is generated by encoding the second computational graph. A prediction score is calculated by decoding the source node embedding and the target node embedding. Weights of the graph neural network are updated using the prediction score.

### TECHNICAL FIELD

The present disclosure generally relates to machine learning, and more specifically, relates to graph neural network approaches to machine learning.

### BACKGROUND ART

Machine learning is a category of artificial intelligence. In machine learning, a model is defined by a machine learning algorithm. A machine learning algorithm is a mathematical and/or logical expression of a relationship between inputs to and outputs of the machine learning model. The model is trained by applying the machine learning algorithm to input data. A trained model can be applied to new instances of input data to generate model output. Machine learning model output can include a prediction, a score, or an inference, in response to a new instance of input data. Application systems can use the output of trained machine learning models to determine downstream execution decisions, such as decisions regarding various user interface functionality.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a graph neural network component in accordance with some embodiments of the present disclosure.

FIG. 2 illustrates another example computing system that includes a graph neural network component in accordance with some embodiments of the present disclosure.

FIG. 3 illustrates an example illustration of an input graph for a graph neural network system in accordance with some embodiments of the present disclosure.

FIG. 4 illustrates another example computing system that includes a graph neural network component in accordance with some embodiments of the present disclosure.

FIG. 5 is a flow diagram of an example method to train a graph neural network using skills in accordance with some embodiments of the present disclosure.

FIG. 6 is a block diagram of an example computer system in which embodiments of the present disclosure can operate.

### DETAILED DESCRIPTION

Graph neural networks (GNNs) are artificial neural networks that are trained to generate outputs for graph input data, i.e., input data in the form of one or more graphs. For example, graph input data can be composed of nodes and edges with pairs of nodes in the graph input data being connected by the edges. The edges are the logical relationships between nodes. A node in the graph input data can be defined by its edges (e.g., the node's logical relationship to other nodes). Nodes that share an edge can be referred to as neighboring nodes.

Some conventional systems use GNNs for modeling and processing input data for online networks (e.g., large online social networks) due to this ability to process graph input data. For example, these online networks can store information about users and entities in the form of graph input data. These conventional systems can use GNNs to generate embeddings for nodes of the graph input data. Given a node of graph input data, the embedding generated by a GNN for that node will be based on one or more of the neighboring nodes of that input node. Thus, given graph input data containing multiple nodes and edges, a node embedding generated by a conventional GNN for a corresponding node of the graph input data will contain information about that node and its respective edges.

Some conventional recommender systems use GNNs to recommend entities to users of an online network by comparing the node embedding for the user and the node embeddings for the candidate entities. For example, a user of an online system is represented as a node in the graph input data and entities in the online system (e.g., posts, other users, etc.) are also represented as nodes in the graph input data. As used herein, “entity” may refer to an object or item that is typically denoted by a noun. Examples of entities include but are not limited to people, organizations, locations, jobs, and/or products. These conventional recommender systems can compare node embeddings generated by the GNN for the user and node embeddings generated by the GNN for the candidate entities to determine which of the candidate entities to recommend to the user.

These conventional recommender systems, however, have shortcomings that present technical challenges to the widespread use of GNNs to generate embeddings for recommender systems. For example, conventional recommender systems can generate inaccurate recommendations for new and/or relatively inactive users. This is because the graph input data for new and/or inactive users is often very sparse, e.g., with poorly connected nodes (e.g., nodes with few edges). For example, a new user of an online system will have little to no data and/or connections with other users/entities of the online system, leading to the representative node embedding being relatively sparse. This sparsity restricts the ability of the recommender system to recommend relevant entities to the new user. The lack of relevant entity recommendations further inhibits the new user's ability to identify entities of interest and use the online system productively. This cycle creates a positive feedback loop known as the cold start problem that continuously inhibits the ability of new users of online systems to receive relevant entity recommendations and thereby prevents the new user from being able to use the system to its full potential.

The shortcomings of these conventional recommender systems are particularly acute when implemented in large online social networks, such as large online professional social networks. For example, new users of large online professional social networks are more likely to be interested in receiving recommendations for specific types of entities, such as job listings, which tend to be very specific to the user. Without sufficient data for these new users, their representational nodes in the graph input data are relatively sparse (e.g., contain few edges) leading to inaccurate recommendations by the recommender system. These inaccurate recommendations prevent the recommender systems from gaining meaningful data from the new user and discourage the new user from further interactions. The end result is that because the recommender system runs on sparse data for new users, the recommendations it produces for new users (based on the sparse data) receive low engagement, further perpetuating the cold start problem.

A graph neural network training system using user skills as described herein includes a number of different components that alone or in combination address the above and other shortcomings of the conventional GNNs, particularly when applied to recommender systems using GNNs for large online systems (e.g., social graph networks). Embodiments of graph neural network training systems as described herein generate input graphs that include user skills represented as nodes in the input graphs. Using the disclosed approaches, a GNN can generate improved node embeddings for user nodes based on the skill-enhanced input graph. GNNs allow for the retention of the dependencies and relationships between these skill-enhanced nodes, resulting in embeddings generated using these GNNs to include more complex information about the nodes than would otherwise be possible. Furthermore, GNNs provide more flexibility for using different node types (e.g., different types of entities) in generating node embeddings, resulting in more relevant node embeddings. These skill-enhanced node embeddings contain significantly more edges, especially for new and inactive users, and therefore more information than conventional node embeddings. As a result, when the improved, skill-enhanced embeddings are used by recommender systems (instead of conventional node embeddings), the stability and accuracy of the recommender systems improves, particularly with respect to new and inactive users. Additionally, embodiments of the graph neural network system described herein can infer skills for the user from other user information, allowing the system to build out even more edges for the user node in the input graph, leading to even higher quality recommendations and increased stability for associated recommender systems.

By including user skills as nodes in input graphs, the graph neural network system as described is able to generate a higher quality node embedding than would otherwise be possible using these skill-enhanced user nodes. For example, rather than solely relying on entities that a user has interacted with, the graph neural network system uses skills for the user to predict entities that the user would interact with, giving the recommender system access to a larger amount of information and therefore higher quality and more stable predictions. By using skills as nodes, the system is also able to generate relevant recommendations for non-active and generally underrepresented groups. For example, because every user has at least one skill (either explicit skill or skills inferred from user data), using skills as nodes naturally creates more comprehensive and inclusive graphs with more edges. Recommendation systems that use these skill-enhances graphs can generate more relevant recommendations for users using the different degrees of relationships that arise from connections using these newly found edges. This can create a system that can generate relevant recommendations more quickly, is more robust in its understanding of the user, and is more capable of adapting to changes in input graphs over time.

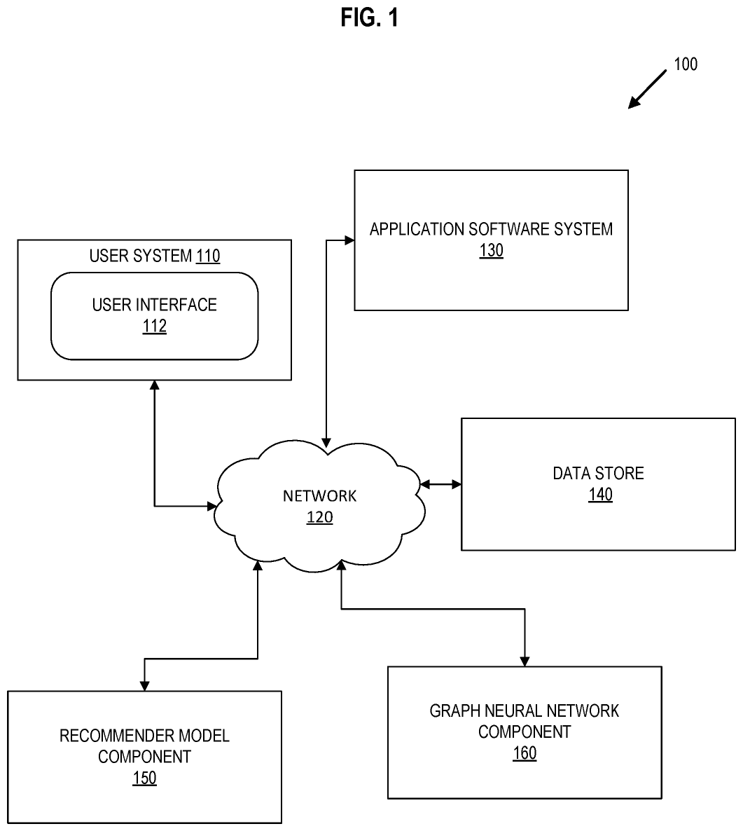

FIG. 1 illustrates an example computing system that includes a graph neural network component in accordance with some embodiments of the present disclosure.

In the embodiment of FIG. 1, computing system 100 includes a user system 110, a network 120, an application software system 130, a data store 140, a recommender model component 150, and a graph neural network component 160. Each of these components of computing system 100 are described in more detail below.

User system 110 includes at least one computing device, such as a personal computing device, a server, a mobile computing device, or a smart appliance. User system 110 includes at least one software application, including a user interface 112, installed on or accessible by a network to a computing device. For example, user interface 112 can be or include a front-end portion of application software system 130.

User interface 112 is any type of user interface as described above. User interface 112 can be used to input search queries and view or otherwise perceive output that includes data produced by application software system 130. For example, user interface 112 can include a graphical user interface and/or a conversational voice/speech interface that includes a mechanism for entering a search query and viewing query results and/or other digital content. Examples of user interface 112 include web browsers, command line interfaces, and mobile apps. User interface 112 as used herein can include application programming interfaces (APIs).

Network 120 can be implemented on any medium or mechanism that provides for the exchange of data, signals, and/or instructions between the various components of computing system 100. Examples of network 120 include, without limitation, a Local Area Network (LAN), a Wide Area Network (WAN), an Ethernet network or the Internet, or at least one terrestrial, satellite or wireless link, or a combination of any number of different networks and/or communication links.

Application software system 130 is any type of application software system that includes or utilizes functionality and/or outputs provided by recommender model component 150 and/or graph neural network component 160. Examples of application software system 130 include but are not limited to online services including connections network software, such as social media platforms, and systems that are or are not be based on connections network software, such as general-purpose search engines, content distribution systems including media feeds, bulletin boards, and messaging systems, special purpose software such as but not limited to job search software, recruiter search software, sales assistance software, advertising software, learning and education software, enterprise systems, customer relationship management (CRM) systems, or any combination of any of the foregoing.

A client portion of application software system 130 can operate in user system 110, for example as a plugin or widget in a graphical user interface of a software application or as a web browser executing user interface 112. In an embodiment, a web browser can transmit an HTTP request over a network (e.g., the Internet) in response to user input that is received through a user interface provided by the web application and displayed through the web browser. A server running application software system 130 and/or a server portion of application software system 130 can receive the input, perform at least one operation using the input, and return output using an HTTP response that the web browser receives and processes.

While not specifically shown, it should be understood that any of user system 110, application software system 130, data store 140, recommender model component 150, and graph neural network component 160 includes an interface embodied as computer programming code stored in computer memory that when executed causes a computing device to enable bidirectional communication with any other of user system 110, application software system 130, data store 140, recommender model component 150, and graph neural network component 160 using a communicative coupling mechanism. Examples of communicative coupling mechanisms include network interfaces, inter-process communication (IPC) interfaces and application program interfaces (APIs).

Data store 140 can include any combination of different types of memory devices. Data store 140 stores digital data used by user system 110, application software system 130, recommender model component 150, and/or graph neural network component 160. Data store 140 can reside on at least one persistent and/or volatile storage device that can reside within the same local network as at least one other device of computing system 100 and/or in a network that is remote relative to at least one other device of computing system 100. Thus, although depicted as being included in computing system 100, portions of data store 140 can be part of computing system 100 or accessed by computing system 100 over a network, such as network 120.

Each of user system 110, application software system 130, data store 140, recommender model component 150, and graph neural network component 160 is implemented using at least one computing device that is communicatively coupled to electronic communications network 120. Any of user system 110, application software system 130, data store 140, recommender model component 150, and graph neural network component 160 can be bidirectionally communicatively coupled by network 120. User system 110 as well as one or more different user systems (not shown) can be bidirectionally communicatively coupled to application software system 130.

A typical user of user system 110 can be an administrator or end user of application software system 130, recommender model component 150, and/or graph neural network component 160. User system 110 is configured to communicate bidirectionally with any of application software system 130, data store 140, recommender model component 150, and/or graph neural network component 160 over network 120.

The features and functionality of user system 110, application software system 130, data store 140, recommender model component 150, and graph neural network component 160 are implemented using computer software, hardware, or software and hardware, and can include combinations of automated functionality, data structures, and digital data, which are represented schematically in the figures. User system 110, application software system 130, data store 140, recommender model component 150, and graph neural network component 160 are shown as separate elements in FIG. 1 for ease of discussion but the illustration is not meant to imply that separation of these elements is required. The illustrated systems, services, and data stores (or their functionality) can be divided over any number of physical systems, including a single physical computer system, and can communicate with each other in any appropriate manner.

The recommender model component 150 trains, updates, evaluates, and implements recommender models including recommender models trained using graph neural networks. Further details with regard to the operations of recommender model component 150 are described below.

The graph neural network component 160 generates neural network graphs for users of an online network (e.g., a large social network) and predicts relational scores for nodes of the neural network graph using user skills. Further details with regard to the operations of graph neural network component 160 are described below.

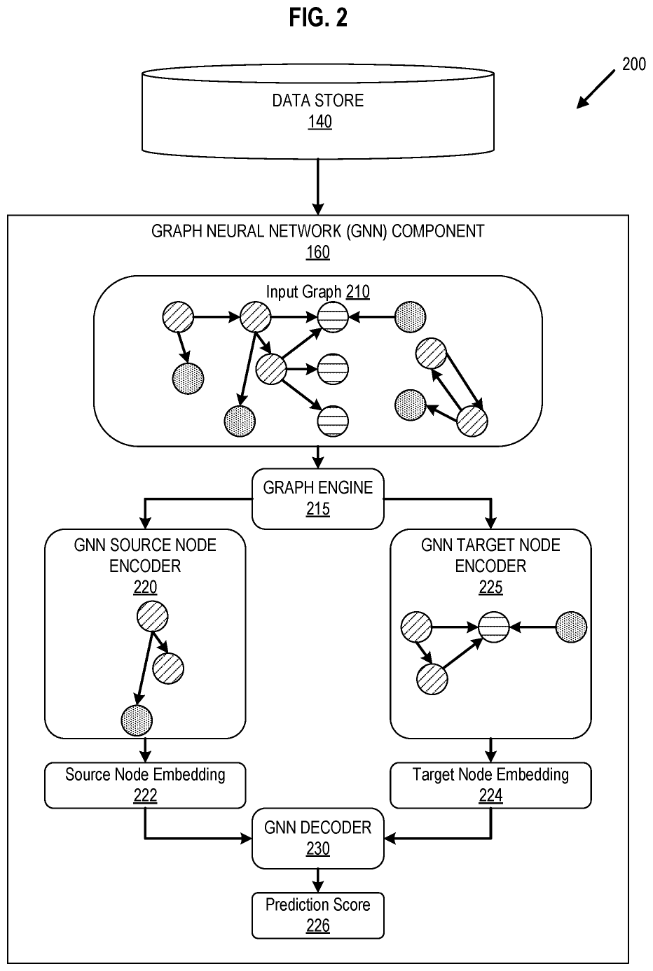

FIG. 2 illustrates another example computing system that includes a graph neural network component in accordance with some embodiments of the present disclosure.

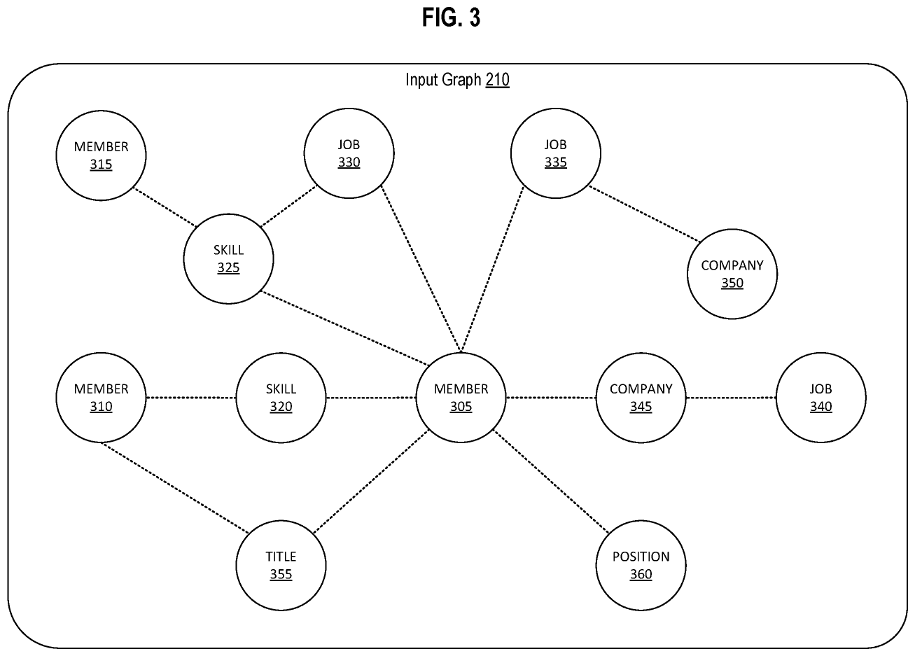

In the embodiment of FIG. 2, graph neural network component 160 includes input graph 210, graph engine 215, graph neural network (GNN) source node encoder 220, GNN target node encoder 225, and GNN decoder 230. Input graph 210, GNN source node encoder 220, and GNN target node encoder 225 include representations of shaded circles representing nodes in each of input graph 210, GNN source node encoder 220, and GNN target node encoder 225. These representations are illustrated for the purpose of explanation and do not necessarily convey the structure and/or representation of actual nodes included in each of input graph 210, GNN source node encoder 220, and GNN target node encoder 225. For example, input graph 210 includes nodes with three different shading patterns, a horizontal line shading pattern, a diagonal line shading pattern, and a dot shading pattern. In some embodiments, each of the shading patterns represents a different entity type and/or skill type. Further details regarding the entity type and/or skill type are explained with reference to FIG. 3.

Graph neural network component 160 receives data from data store 140 and generates input graph 210. For example, graph neural network component 160 receives content items (e.g., data for users and entities of a social graph network) from data store 140. In some embodiments, these content items are graphically structured such that the content items can be represented by a graph such as input graph 210. As used herein, “content items” may refer both to an object or item that is typically denoted by a noun (e.g., an entity) and/or to attributes (e.g., skills) of that object or item. Content items, therefore, include both entities and skills concerning those entities. The nodes illustrated in input graph 210 can represent objects in a graph where the graph is represented by a data structure G, where G=(V, E) with V representing objects (e.g., nodes) in the graph and E representing edges connecting pairs of objects. In some embodiments, input graph 210 includes data such as links between users of an online social graph network based on various affinity criteria such as connections, messages, and followers. For example, the objects V for graphical data structure G include content items represented as nodes in the graph and the edges E connecting the users can include user connections (e.g., shared skills), messages between users, and followers. Content items of input graph 210 include entities of the online social graph network represented as nodes. For example, these entities include but are not limited to users of the social graph network, job postings, recruiters, companies, organizations, locations, products, etc. Content items of input graph 210 also includes certain entity attributes represented as nodes. For example, these attributes can include but are not limited to explicit skills, implied skills, job title, position, job industry, seniority, geographical information, a parent occupation, etc. These skills nodes are connected to entity nodes through edges that may be explicitly defined by entity data and/or implicitly derived by example computing system 200. For example, a user of a social graph network includes information about their skills in their user profile. In some embodiments, this skill information is input but a user (e.g., a user interacting with user interface 112 of user system 110 of FIG. 1). For example, a user selects an explicit skill from user interface 112 and/or otherwise interacts with user interface 112 causing user system 110 to send the explicit skill through application software system 130 to be stored in data store 140. Graph neural network component 160 retrieves the explicit skills from data store 140 to construct input graph 210.

In some embodiments, graph neural network component 160 computationally or programmatically implies skills based on other user input. For example, a user interacts with user interface 112 to input a current job position causing user system 110 to send the current job position to be stored in data store 140. Graph neural network component 160 determines implied skills for the user based on the user input of the current job position. For example, graph neural network component 160 searches for skills associated with that job position and includes them as implied skills for the user.

In some embodiments, graph neural network component 160 generates input graph 210 with entities such as users, job listings, companies, job titles as nodes in input graph 210. For example, graph neural network component 160 receives a content item including a job listing from data store 140. The job listing includes programming in C as a skill for an associated job. In such an example, graph neural network component 160 creates input graph 210 including a first node representing the job listing and a second node representing the skill of programming in C, with these nodes being linked in input graph 210. Graph neural network component 160 also links the second node (e.g., the skill of programming in C) with other job postings including the skill of programming in C, users that have the skill of programming in C, job titles that include the skill of programming in C, etc.

In some embodiments, graph neural network component 160 filters the skills for the entities in data store 140. For example, broader skills such as a proficiency in Microsoft Word will appear in a lot of different job postings, user data, etc. but have little bearing on whether a user would apply to that job posting. Graph neural network component 160 therefore filters the skills such that the most important, relevant, and/or unique skills are included as connected nodes for each of the entities. In some embodiments, graph neural network component 160 ranks the skills for each entity and includes the skills which satisfy a ranking threshold. In other embodiments, graph neural network component 160 determines a top N number of skills based on the ranking. In some embodiments, graph neural network component 160 ranks explicit skills higher than implicit skills. For example, an explicit skill input by a user into user interface 112 is ranked higher than an implied skill determined by the system from a user's job title. In some embodiments, graph neural network component 160 ranks the skills using confidence scores. For example, graph neural network component 160 filters out skills with confidence scores that fall below a confidence score threshold.

Graph neural network component 160 inputs input graph 210 into graph engine 215. For example, input graph 210 includes nodes, edges, and features. Features of input graph 210 represent attributes for the node. For example, features of a user include attributes such as explicit skills, implied skills, job title, position, job industry, seniority, geographical information, a parent occupation, etc. In some embodiments, these features are processed vectors that can have multiple entries. For example, features can include a node entity indicating the node type for a given node (e.g., skill, title, etc.) In some embodiments, graph neural network component 160 trains a graph neural network model by generating input data including a source node and a target node. For example, graph neural network component 160 generates a computational graph for each of the source node and the target node. As shown in FIG. 2, graph engine 215 samples the neighbors for the source node in input graph 210 and generates a first computational graph for the source node (e.g., illustrated in GNN source node encoder 220). Graph engine 215 also samples the neighbors for the target node in input graph 210 and generates a second computational graph for the target node (e.g., illustrated in GNN target node encoder 225). Each of the generated computations graphs includes the sampled neighbors for each of the source node and the target node as well as related features for the sampled neighbors. Graph engine 215 sends the generated computational graphs to each of GNN source node encoder 220 and GNN target node encoder 225.

GNN source node encoder 220 receives the first computational graph (e.g., source node computational graph) and generates source node embedding 222 using the first computational graph. For example, GNN source node encoder 220 aggregates the information from the sampled node neighbors in the source node computational graph and updates representations for the source node based on the aggregated information. The aggregated information includes, for example, features of the neighboring nodes. Accordingly, GNN source node encoder 220 generates source node embedding 222 including aggregated features from the neighboring nodes of the source node.

GNN target node encoder 225 receives the second computational graph (e.g., target node computational graph) and generates target node embedding 224 using the second computational graph. For example, GNN target node encoder 225 aggregates the information from the sampled node neighbors in the target node computational graph and updates representations for the target node based on the aggregated information. The aggregated information includes, for example, features of the neighboring nodes. Accordingly, GNN target node encoder 225 generates target node embedding 224 including aggregated features from the neighboring nodes of the target node.

In some embodiments, each of GNN source node encoder 220 and/or GNN target node encoder 225 generate their associated embeddings (e.g., source node embedding 222 and target node embedding 224 using a min function. For example, GNN source node encoder 220 aggregates features for two neighboring nodes of the source node. GNN source node encoder 220 takes a min of these features such that source node embedding 222 includes feature information for the smaller feature value of the two neighboring nodes. Similarly, GNN target node encoder 225 aggregates features for the three neighboring nodes of the target node. GNN target node encoder 225 takes a min of these features such that target node embedding 224 includes feature information for the smallest feature value of the three neighboring nodes.

In some embodiments, each of GNN source node encoder 220 and/or GNN target node encoder 225 generate their associated embeddings (e.g., source node embedding 222 and target node embedding 224 using a max function. For example, GNN source node encoder 220 aggregates features for two neighboring nodes of the source node. GNN source node encoder 220 takes a max of these features such that source node embedding 222 includes feature information for the larger feature value of the two neighboring nodes. Similarly, GNN target node encoder 225 aggregates features for the three neighboring nodes of the target node. GNN target node encoder 225 takes a max of these features such that target node embedding 224 includes feature information for the largest feature value of the three neighboring nodes.

Accordingly, by using an aggregation function (e.g., min function and/or max function), GNN source node encoder 220 and GNN target node encoder 225 generate source node embedding 222 and target node embedding 224 respectively that match each other (e.g., share the same vector space). In some embodiments, each of GNN source node encoder 220 and GNN target node encoder 225 use aggregation functions specific to the feature. For example, GNN source node encoder 220 and GNN target node encoder 225 use a min function for one feature and a max function for another.

Each of GNN source node encoder 220 and GNN target node encoder 225 send source node embedding 222 and target node embedding 224 to GNN decoder 230. GNN decoder 230 receives source node embedding 222 and target node embedding 224 and calculates prediction score 226 for the pair. For example, GNN decoder 230 determines a distance in the vector space defined by source node embedding 222 and target node embedding 224 such that a smaller distance in the vector space corresponds with a higher degree of similarity and a larger distance in the vector space corresponds with a lower degree of similarity.

In some embodiments, graph neural network component 160 updates weights of the graph neural network based on prediction score 226. For example, graph neural network component 160 determines a loss using prediction score prediction score 226 and updates weights for the graph neural network based on the determined loss. In some embodiments, graph neural network component 160 updates the weights for the graph neural network using stochastic gradient descent. For example, the weights of the graph neural network represent the weights of the features of the nodes. Accordingly, graph neural network component 160 updates the weights for features based on the loss to put more and less emphasis on certain features for determining the similarity of the source node and the target node.

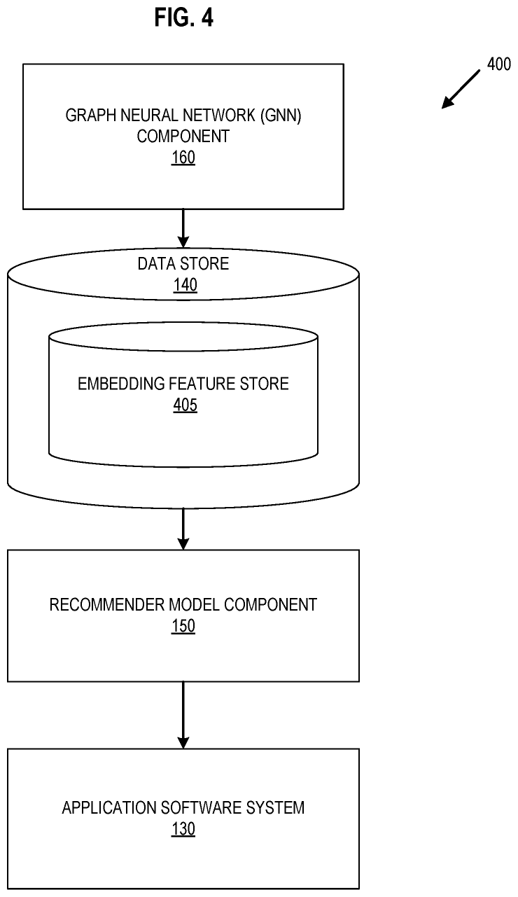

In some embodiments, graph neural network component 160 stores source node embedding 222 and target node embedding 224 in a data store (e.g., data store 140 of FIGS. 1 and 4). For example, during inference using the graph neural network (e.g., as opposed to training), graph neural network component 160 stores source node embedding 222 and target node embedding 224 for use in downstream retrieval and/or ranking models. Further details regarding using source node embedding and target node embedding for downstream models is explained with reference to FIG. 4.

FIG. 3 illustrates an example illustration of an input graph for a graph neural network system in accordance with some embodiments of the present disclosure. As shown in FIG. 3, input graph 210 includes nodes linked by edges. Each of these nodes represents content item such as an entity or a skill. In one example, nodes include member nodes 305, 310, and 315, skill nodes 320 and 325, job nodes 330, 335, and 340, company nodes 345 and 350, title node 355, and position node 360. The entity and skill types shown in FIG. 3 as well as their number are for the purposes of illustration and are not intended to be restricting.

In one embodiment, member node 305 represents a user of an online social graph network. For example, a user represented by member node 305 interacts with user interface 112 of user system 110, causing computing system 200 to retrieve input graph 210. Member node 305 is linked through edges to each of skill nodes 320 and 325, job nodes 330 and 335, company node 345, title node 355, and position node 360. For example, a user profile for the user represented by member node 305 includes implied skill data corresponding with skill node 320, explicit skill data corresponding with skill node 325, activity data including a saved job listing corresponding with job node 330, a job listing application corresponding with job node 335, a current company of employment corresponding with company node 345, a current job title corresponding with title node 355, and a current position corresponding with position node 360. Accordingly, member node 305 is linked to each of these nodes in the GNN through edges of member node 305.

In some embodiments, as shown in FIG. 3, input graph 210 also include member node 310 connected to member node 305 through skill node 320 and title node 355. For example, member node 310 represents another user of the social graph network with the same or similar job title to the user represented by member node 305. In some embodiments, graph neural network component 160 generates an implied skill represented by skill node 320 for member node 305 based on the shared title node 355 for member nodes 305 and 310. For example, because member nodes 305 and 310 share the same or similar job title, graph neural network component 160 determines that skill node 320 is a skill for job associated with title node 355 and includes skill node 320 as an implied skill for member node 305.

In some embodiments, skill node 325 represents an explicit skill input by the user associated with member node 305. Member node 315 is connected to member node 305 through skill node 325. Accordingly, skill node 325 is an explicit and/or implied skill for the user represented by member node 315. Company node 350 represents an organization and/or company associated with the job listing represented by job node 335. For example, company node 350 represents the company that is hiring for the job represented by job node 335. Job node 340 represents a job posting associated with the company represented by company node 345. For example, job node 340 represents a job listing associated with the company and/or organization represented by company node 345.

In some embodiments, the edges between the nodes represent the relationship between the entities and/or attributes. For example, the edge between member node 305 and job node 330 represents that the user represented by member node 305 saved the job listing represented by job node 330. Similarly, the edge between member node 305 and job node 335 represents that the user represented by member node 305 applied to the job listing represented by job node 335.

As explained with reference to FIG. 2, graph neural network component 160 generates a computational graph for each of the source node and the target node. For example, for the example shown in FIG. 3, graph neural network component 160 generates a computational graph for member node 305. In such an example, graph neural network component 160 samples each of skill nodes 320 and 325, job nodes, 330 and 335, company node 345, title node 355, and position node 360. The generated computational graph for member node 305 also includes features of each of these neighboring nodes. For example, the generated computational graph for member node 305 includes features of each of skill nodes 320 and 325, job nodes, 330 and 335, company node 345, title node 355, and position node 360.

Continuing with the above example, graph neural network component 160 generates a computational graph for job node 340 (e.g., target node). In such an example, graph neural network component 160 samples company node 345 as well as other unillustrated nodes connected to job node 340. The generated computational graph for job node 340 includes features of these neighboring nodes (e.g., features of company node 345).

As explained with reference to FIG. 2, GNN source node encoder 220 receives the computational graph for member node 305 and generates source node embedding 222 using the computational graph. For example, GNN source node encoder 220 aggregates the feature information for each of skill nodes 320 and 325, job nodes, 330 and 335, company node 345, title node 355, and position node 360 and updates representations for member node 305 based on the aggregated information. Additionally, GNN target node encoder 225 receives the computational graph for job node 340 and generates target node embedding 224 using the computational graph. For example, GNN target node encoder 225 aggregates the feature information for company node 345 and unillustrated neighbor nodes.

As explained with reference to FIG. 2, in some embodiments, GNN decoder 230 calculates prediction score 226 for source node embedding 222 and target node embedding 224. For example, GNN decoder 230 calculates a distance between source node embedding 222 representing member node 305 and the target node embedding representing job node 340. In some embodiments, graph neural network component 160 can train a graph neural network model using prediction score 226. In other embodiments, graph neural network component 160 stores source node embedding 222 and/or target node embedding 224 in data store 140 for future use. Further details regarding graph neural network component 160 storing embeddings in data store 140 for future use is described with reference to FIG. 4.

FIG. 4 illustrates another example computing system that includes a graph neural network component in accordance with some embodiments of the present disclosure. As shown in FIG. 4, computing system 400 includes graph neural network component 160, data store 140, recommender model component 150, and application software system 130. Data store 140 includes embedding feature store 405. Embedding feature store 405 can include any combination of different types of memory devices. Embedding feature store 405 stores embeddings used by user system 110, application software system 130, recommender model component 150, and/or graph neural network component 160. For example, feature store 405 includes embeddings for nodes of input graph 210.

As shown in FIG. 4, graph neural network component 160 sends embeddings to data store 140 to store in embedding feature store 405. For example, graph neural network component 160 stores the updated representations generated by each of GNN source node encoder 220 and GNN target node encoder 225 (e.g., source node embedding 222 and target node embedding 224) in embedding feature store 405.

Recommender model component 150 retrieves embeddings from embedding feature store 405. For example, in response to a request from application software system 130, recommender model component 150 retrieves embeddings associated with a user of a social graph network. In some embodiments, a user interacting with user interface 112 of user system 110 causes application software system 130 to retrieve embeddings associated with that user from embedding feature store 405. For example, in response to a user logging into their account, application software system 130 retrieves embeddings for the user and potential content items to display to the user. In some embodiments, recommender model component 150 includes candidate selection and ranking models for ranking content items using the retrieved embeddings. For example, recommender model component 150 performs a similarity search using the embedding for the user and embeddings for candidate content items and selects candidate content items with a similar search score that satisfies a threshold. In some embodiments, the selected candidate content items are input to a ranking model which ranks the candidate content items using the embeddings. By using a single embedding layer to provide embeddings for multiple downstream applications including candidate selection and ranking models, the recommender system uses fewer data signals to generate the recommendation. For example, graph neural network component 160 generates an embedding for each node in input graph 210. Recommender model component 150 therefore only needs to retrieve a single embedding for each entity in the candidate selection and ranking process rather than generating fresh embeddings during selection and again during ranking. Accordingly, recommender model component 150 is able to provide recommendations more efficiently and quickly than conventional recommender systems.

In some embodiments, the candidate selection and/or ranking models include other features related to the user and/or content items associated with the retrieved embeddings. For example, recommender model component 150 generates input data for a candidate selection and/or ranking model using the retrieved embeddings and associated features. In such an embodiment, recommender model component 150 determines an output of the candidate selection and/or ranking models by applying the candidate selection and/or ranking models to the input data. For example, recommender model component 150 determines a content item to recommend to the user of user system 110 by applying the candidate selection and/or ranking models to the input data including the retrieved embeddings. In some embodiments, recommender model component 150 sends the recommended content item to application software system 130 causing user system 110 to display the recommended content item on user interface 112 of user system 110.

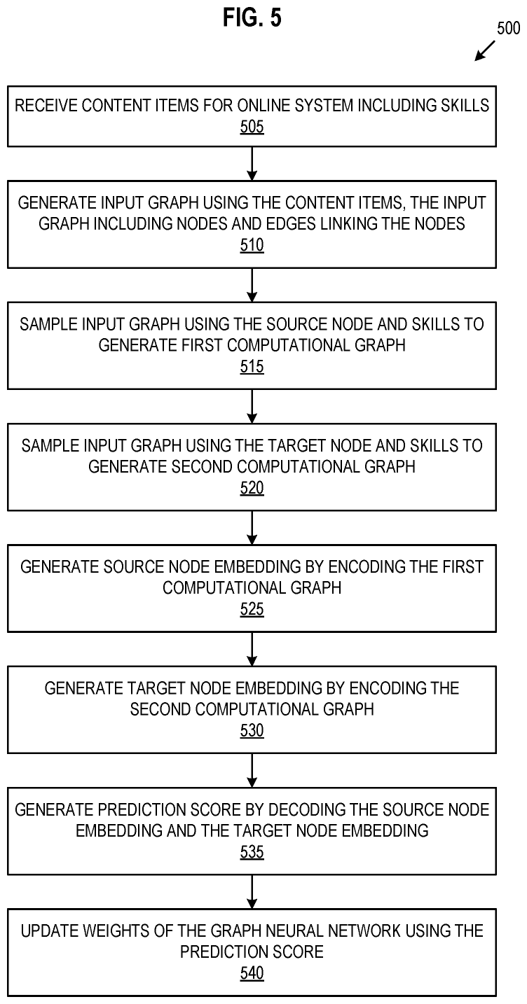

FIG. 5 is a flow diagram of an example method 500 to train a graph neural network using skills, in accordance with some embodiments of the present disclosure. The method 500 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 500 is performed by graph neural network component 160 of FIG. 1. In some embodiments, parts of the method 500 are performed by recommender model component 150 and parts of the method 500 are performed by graph neural network component 160 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 505, the processing device receives content items for an online system including skills. For example, graph neural network component 160 received content items for a user of an online system including explicit and/or implied skills for the user. In some embodiments, graph neural network component 160 determines implied skills for the user based on user data. For example, graph neural network component 160 determines implied skills for the user based on a job title for the user. In some embodiments, the processing device filters skills for the content items. For example, graph neural network component 160 ranks the skills for each entity and includes the skills which satisfy a ranking threshold. In other embodiments, the processing device determines a top N number of skills based on the ranking. In some embodiments, the processing device ranks explicit skills higher than implicit skills. For example, an explicit skill input by a user into user interface 112 is ranked higher than an implied skill determined by the system from a user's job title. Further details regarding receiving content items including skills are discussed with reference to FIGS. 2-4.

At operation 510, the processing device generates an input graph using the content items. The input graph includes nodes and edges linking the nodes. For example, graph neural network component 160 generates input graph 210 including nodes representing entities and skills. In some embodiments, the input graph includes features for the nodes. Further details regarding generating an input graph using the content items are discussed with reference to FIGS. 2-4.

At operation 515, the processing device samples the input graph using the source node and the skills to generate a first computational graph. For example, graph neural network component 160 samples neighbors of the source node and generates a first computational graph for the source node using the neighboring nodes and features of the neighboring nodes. Further details regarding sampling the input graph using the source node and the skills are discussed with reference to FIGS. 2-4.

At operation 520, the processing device samples the input graph using the target node and the skills to generate a second computational graph. For example, graph neural network component 160 samples neighbors of the target node and generates a second computational graph for the target node using the neighboring nodes and features of the neighboring nodes. Further details regarding sampling the input graph using the target node and the skills are discussed with reference to FIGS. 2-4.

At operation 525, the processing device generates a source node embedding by encoding the first computational graph. For example, GNN source node encoder 220 generates source node embedding 222 by aggregating the features of the neighboring nodes of the source node and updating the representation of the source node (e.g., source node embedding 222) based on these aggregated features. Further details regarding generating a source node embedding by encoding the first computation graph are discussed with reference to FIGS. 2-4.

At operation 530, the processing device generates a target node embedding by encoding the second computational graph. For example, GNN target node encoder 225 generates target node embedding 224 by aggregating the features of the neighboring nodes of the target node and updating the representation of the target node (e.g., target node embedding 224) based on these aggregated features. Further details regarding generating a target node embedding by encoding the second computation graph are discussed with reference to FIGS. 2-4.

At operation 535, the processing device generates a prediction score by decoding the source node embedding and the target node embedding. For example, GNN decoder 230 generates prediction score 226 by comparing the similarity of source node embedding 222 and target node embedding 224 in their shared vector space. Further details regarding generating a prediction score are discussed with reference to FIGS. 2-4.

At operation 540, the processing device updates weights of the graph neural network using the prediction score. For example, graph neural network component 160 updates weights for the graph neural network using prediction score 226. In some embodiments, graph neural network component 160 uses a training prediction score and updates the weights for the graph neural network based on a loss determined by comparing the training prediction score and prediction score 226. Further details regarding updating the weights of the graph neural network are discussed with reference to FIGS. 2-4.

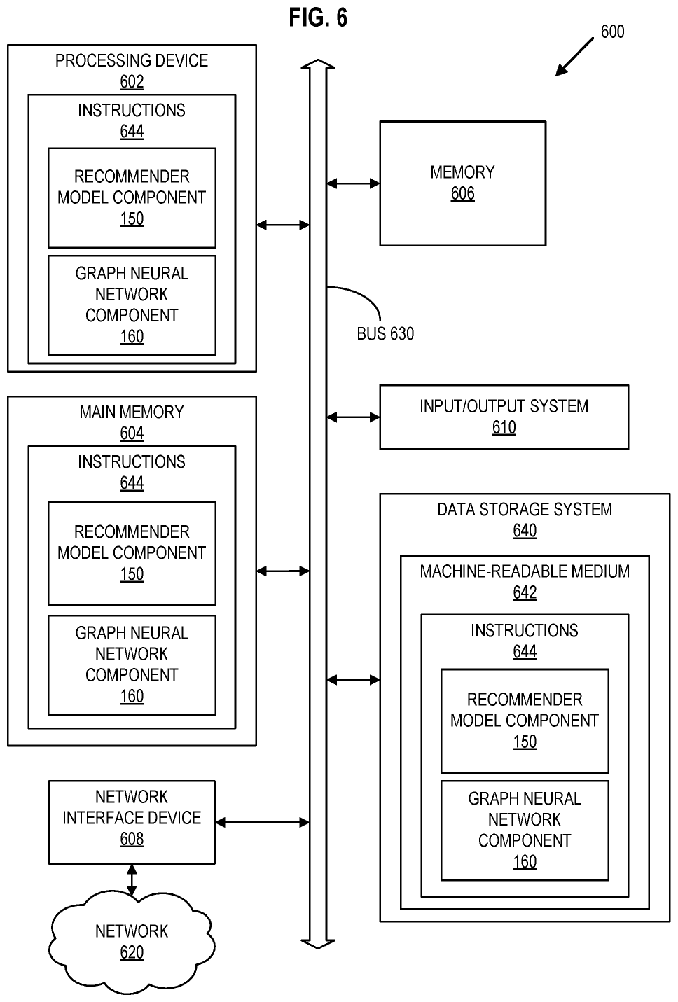

FIG. 6 illustrates an example machine of a computer system 600 within which a set of instructions, for causing the machine to perform any one or more of the methodologies discussed herein, can be executed. In some embodiments, the computer system 600 can correspond to a component of a networked computer system (e.g., computing system 100 of FIG. 1) that includes, is coupled to, or utilizes a machine to execute an operating system to perform operations corresponding to recommender model component 150 and/or graph neural network component 160 of FIG. 1. The machine can be connected (e.g., networked) to other machines in a local area network (LAN), an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine can be a personal computer (PC), a smart phone, a tablet PC, a set-top box (STB), a Personal Digital Assistant (PDA), a cellular telephone, a web appliance, a server, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., read-only memory (ROM), flash memory, dynamic random-access memory (DRAM) such as synchronous DRAM (SDRAM) or Rambus DRAM (RDRAM), etc.), a memory 606 (e.g., flash memory, static random-access memory (SRAM), etc.), an input/output system 610, and a data storage system 640, which communicate with each other via a bus 630.

Processing device 602 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 602 can also be one or more special-purpose processing devices such as an application specific integrated circuit (ASIC), a field programmable gate array (FPGA), a digital signal processor (DSP), network processor, or the like. The processing device 602 is configured to execute instructions 644 for performing the operations and steps discussed herein.

The computer system 600 can further include a network interface device 608 to communicate over the network 620. Network interface device 608 can provide a two-way data communication coupling to a network. For example, network interface device 608 can be an integrated-services digital network (ISDN) card, cable modem, satellite modem, or a modem to provide a data communication connection to a corresponding type of telephone line. As another example, network interface device 608 can be a local area network (LAN) card to provide a data communication connection to a compatible LAN. Wireless links can also be implemented. In any such implementation, network interface device 608 can send and receive electrical, electromagnetic or optical signals that carry digital data streams representing various types of information.

The network link can provide data communication through at least one network to other data devices. For example, a network link can provide a connection to the world-wide packet data communication network commonly referred to as the “Internet,” for example through a local network to a host computer or to data equipment operated by an Internet Service Provider (ISP). Local networks and the Internet use electrical, electromagnetic or optical signals that carry digital data to and from computer system computer system 600.

Computer system 600 can send messages and receive data, including program code, through the network(s) and network interface device 608. In the Internet example, a server can transmit a requested code for an application program through the Internet and network interface device 608. The received code can be executed by processing device 602 as it is received, and/or stored in data storage system 640, or other non-volatile storage for later execution.

The input/output system 610 can include an output device, such as a display, for example a liquid crystal display (LCD) or a touchscreen display, for displaying information to a computer user, or a speaker, a haptic device, or another form of output device. The input/output system 610 can include an input device, for example, alphanumeric keys and other keys configured for communicating information and command selections to processing device 602. An input device can, alternatively or in addition, include a cursor control, such as a mouse, a trackball, or cursor direction keys for communicating direction information and command selections to processing device 602 and for controlling cursor movement on a display. An input device can, alternatively or in addition, include a microphone, a sensor, or an array of sensors, for communicating sensed information to processing device 602. Sensed information can include voice commands, audio signals, geographic location information, and/or digital imagery, for example.

The data storage system 640 can include a machine-readable storage medium 642 (also known as a computer-readable medium) on which is stored one or more sets of instructions 644 or software embodying any one or more of the methodologies or functions described herein. The instructions 644 can also reside, completely or at least partially, within the main memory 604 and/or within the processing device 602 during execution thereof by the computer system 600, the main memory 604 and the processing device 602 also constituting machine-readable storage media.

In one embodiment, the instructions 644 include instructions to implement functionality corresponding to a recommender model component (e.g., recommender model component 150 of FIG. 1). In another embodiment, the instructions 644 include instructions to implement functionality corresponding to a graph neural network component (e.g., graph neural network component 160 of FIG. 1). In yet another embodiment, the instructions 644 include instructions to implement functionality corresponding to both a recommender model component and a graph neural network component (e.g., recommender model component 150 and graph neural network component 160 of FIG. 1). While the machine-readable storage medium 642 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

The techniques described herein may be implemented with privacy safeguards to protect user privacy. Furthermore, the techniques described herein may be implemented with user privacy safeguards to prevent unauthorized access to personal data and confidential data. The training of the AI models described herein is executed to benefit all users fairly, without causing or amplifying unfair bias.

An example 1 includes a method for training a graph neural network comprising: receiving a plurality of content items for a user of an online system, wherein the plurality of content items comprises a plurality of skills; generating an input graph using the plurality of content items, wherein the input graph comprises a plurality of nodes and a plurality of edges linking the plurality of nodes, wherein the plurality of nodes comprises a source node, a target node, and the plurality of skills; sampling the input graph using the source node and the plurality of skills to generate a first computational graph for the source node; sampling the input graph using the target node and the plurality of skills to generate a second computational graph for the target node; generating a source node embedding by encoding the first computational graph; generating a target node embedding by encoding the second computational graph; calculating a prediction score by decoding the source node embedding and the target node embedding, wherein the prediction score comprises a predicted similarity between the source node and the target node based on the decoded source node embedding and the decoded target node embedding; and updating weights of the graph neural network using the prediction score. An example 2 includes the subject matter of example 1, further including filtering the plurality of skills for the plurality of content items. An example 3 includes the subject matter of any of examples 1 and 2, wherein the plurality of skills includes one or more implied skills, the method further comprising: generating the implied skill for the user using one or more content items of the plurality of content items, wherein the one or more content items are attributes of the user. An example 4 includes the subject matter of any of examples 1-3, wherein the input graph further comprises a feature set for each of the plurality of nodes, wherein sampling the input graph using the source node comprises: determining a first set of neighboring nodes of the plurality of nodes for the source node using the plurality of skills; and sampling the first set of neighboring nodes to determine a feature set for each of the first set of neighboring nodes. An example 5 includes the subject matter of example 4, wherein generating the source node embedding comprises: aggregating the feature sets for each of the first set of neighboring nodes; and generating the source node embedding using the aggregated feature sets. An example 6 includes the subject matter of any of examples 4 and 5, wherein the input graph further comprises a feature set for each of the plurality of nodes, wherein sampling the input graph using the target node comprises: determining a second set of neighboring nodes of the plurality of nodes for the target node using the plurality of skills; and sampling the second set of neighboring nodes to determine a feature set for each of the second set of neighboring nodes. An example 7 includes the subject matter of example 6, wherein generating the target node embedding comprises: aggregating the feature sets for each of the second set of neighboring nodes; and generating the target node embedding using the aggregated feature sets for the second set of neighboring nodes. An example 8 includes the subject matter of any of examples 1-7, wherein calculating the prediction score comprises: determining a distance in a vector space for the source node embedding and the target node embedding; and calculating the prediction score using the distance. An example 9 includes the subject matter of any of examples 1-8, wherein calculating the prediction score comprises: determining a distance in a vector space for the source node embedding and the target node embedding; and calculating the prediction score using the distance. An example 10 includes the subject matter of any of examples 1-9, wherein calculating the prediction score comprises: determining a distance in a vector space for the source node embedding and the target node embedding; and calculating the prediction score using the distance. An example 11 includes the subject matter of example 10, wherein determining the loss comprises: determining the loss by applying a gradient descent loss function to the prediction score and the training prediction score.

An example 12 includes a system for training a graph neural network comprising: at least one memory device; and a processing device, operatively coupled with the at least one memory device, to: receive a plurality of content items for a user of an online system, wherein the plurality of content items comprises a plurality of skills; generate an input graph using the plurality of content items, wherein the input graph comprises a plurality of nodes and a plurality of edges linking the plurality of nodes, wherein the plurality of nodes comprises a source node, a target node, and the plurality of skills; sample the input graph using the source node and the plurality of skills to generate a first computational graph for the source node; sample the input graph using the target node and the plurality of skills to generate a second computational graph for the target node; generate a source node embedding by encoding the first computational graph; generate a target node embedding by encoding the second computational graph; calculate a prediction score by decoding the source node embedding and the target node embedding, wherein the prediction score comprises a predicted similarity between the source node and the target node based on the decoded source node embedding and the decoded target node embedding; and updating weights of the graph neural network using the prediction score. An example 13 includes the subject matter of example 12, wherein the processing device is further to filter the plurality of skills for the plurality of content items. An example 14 includes the subject matter of any of examples 12 and 13, wherein the plurality of skills includes one or more implied skills and wherein the processing device is further to: generate the implied skill for the user using one or more content items of the plurality of content items, wherein the one or more content items are attributes of the user. An example 15 includes the subject matter of any of examples 12-14, wherein the input graph further comprises a feature set for each of the plurality of nodes, wherein sampling the input graph using the source node comprises: determining a first set of neighboring nodes of the plurality of nodes for the source node using the plurality of skills; and sampling the first set of neighboring nodes to determine a feature set for each of the first set of neighboring nodes. An example 16 includes the subject matter of example 15, wherein generating the source node embedding comprises: aggregating the feature sets for each of the first set of neighboring nodes; and generating the source node embedding using the aggregated feature sets. An example 17 includes the subject matter of any of examples 15 and 16, wherein the input graph further comprises a feature set for each of the plurality of nodes, wherein sampling the input graph using the target node comprises: determining a second set of neighboring nodes of the plurality of nodes for the target node using the plurality of skills; and sampling the second set of neighboring nodes to determine a feature set for each of the second set of neighboring nodes. An example 18 includes the subject matter of example 17, wherein generating the target node embedding comprises: aggregating the feature sets for each of the second set of neighboring nodes; and generating the target node embedding using the aggregated feature sets for the second set of neighboring nodes. An example 19 includes the subject matter of any of examples 12-18, wherein generating the target node embedding comprises: aggregating the feature sets for each of the second set of neighboring nodes; and generating the target node embedding using the aggregated feature sets for the second set of neighboring nodes.

An example 20 includes a system for training a graph neural network comprising: at least one memory device; and a processing device, operatively coupled with the at least one memory device, to: receive a plurality of content items for a user of an online system, wherein the plurality of content items comprises a plurality of skills; filter the plurality of skills for the plurality of content items; generate an input graph using the plurality of content items, wherein the input graph comprises a plurality of nodes and a plurality of edges linking the plurality of nodes, wherein the plurality of nodes comprises a source node, a target node, and the filtered plurality of skills; sample the input graph using the source node and the filtered plurality of skills to generate a first computational graph for the source node; sample the input graph using the target node and the filtered plurality of skills to generate a second computational graph for the target node; generate a source node embedding by encoding the first computational graph; generate a target node embedding by encoding the second computational graph; calculate a prediction score by decoding the source node embedding and the target node embedding, wherein the prediction score comprises a predicted similarity between the source node and the target node based on the decoded source node embedding and the decoded target node embedding; and update weights of the graph neural network using the loss.

According to some embodiments, the techniques for the models described herein do not make inferences or predictions about individuals unless requested to do so through an input. According to some embodiments, the models described herein do not learn from and are not trained on user data without user authorization. In instances where user data is permitted and authorized for use in AI features and tools, it is done in compliance with a user's visibility settings, privacy choices, user agreement and descriptions, and the applicable law. According to the techniques described herein, users may have full control over the visibility of their content and who sees their content, as is controlled via the visibility settings. According to the techniques described herein, users may have full control over the level of their personal data that is shared and distributed between different AI platforms that provide different functionalities. According to the techniques described herein, users may have full control over the level of access to their personal data that is shared with other parties. According to the techniques described herein, personal data provided by users may be processed to determine prompts when using a generative AI feature at the request of the user, but not to train generative AI models. In some embodiments, users may provide feedback while using the techniques described herein, which may be used to improve or modify the platform and products. In some embodiments, any personal data associated with a user, such as personal information provided by the user to the platform, may be deleted from storage upon user request. In some embodiments, personal information associated with a user may be permanently deleted from storage when a user deletes their account from the platform.

According to the techniques described herein, personal data may be removed from any training dataset that is used to train AI models. The techniques described herein may utilize tools for anonymizing member and customer data. For example, user's personal data may be redacted and minimized in training datasets for training AI models through delexicalization tools and other privacy enhancing tools for safeguarding user data. The techniques described herein may minimize use of any personal data in training AI models, including removing and replacing personal data. According to the techniques described herein, notices may be communicated to users to inform how their data is being used and users are provided controls to opt-out from their data being used for training AI models.

According to some embodiments, tools are used with the techniques described herein to identify and mitigate risks associated with AI in all products and AI systems. In some embodiments, notices may be provided to users when AI tools are being used to provide features.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system, such as the computing system 100, can carry out the computer-implemented method 500 in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

Illustrative examples of the technologies disclosed herein are provided below. An embodiment of the technologies may include any of the examples or a combination of the described below.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method for training a graph neural network comprising:
receiving a plurality of content items for a user of an online system, wherein the plurality of content items comprises a plurality of skills;
generating an input graph using the plurality of content items, wherein the input graph comprises a plurality of nodes and a plurality of edges linking the plurality of nodes, wherein the plurality of nodes comprises a source node, a target node, and the plurality of skills;
sampling the input graph using the source node and the plurality of skills to generate a first computational graph for the source node;
sampling the input graph using the target node and the plurality of skills to generate a second computational graph for the target node;
generating a source node embedding by encoding the first computational graph;
generating a target node embedding by encoding the second computational graph;
calculating a prediction score by decoding the source node embedding and the target node embedding, wherein the prediction score comprises a predicted similarity between the source node and the target node based on the decoded source node embedding and the decoded target node embedding; and
updating weights of the graph neural network using the prediction score.

2. The method of claim 1, further comprising:
filtering the plurality of skills for the plurality of content items.

3. The method of claim 1, wherein the plurality of skills includes one or more implied skills, the method further comprising:
generating the implied skill for the user using one or more content items of the plurality of content items, wherein the one or more content items are attributes of the user.

4. The method of claim 1, wherein the input graph further comprises a feature set for each of the plurality of nodes, wherein sampling the input graph using the source node comprises:
determining a first set of neighboring nodes of the plurality of nodes for the source node using the plurality of skills; and
sampling the first set of neighboring nodes to determine a feature set for each of the first set of neighboring nodes.

5. The method of claim 4, wherein generating the source node embedding comprises:
aggregating the feature sets for each of the first set of neighboring nodes; and
generating the source node embedding using the aggregated feature sets.

6. The method of claim 4, wherein the input graph further comprises a feature set for each of the plurality of nodes, wherein sampling the input graph using the target node comprises:
determining a second set of neighboring nodes of the plurality of nodes for the target node using the plurality of skills; and
sampling the second set of neighboring nodes to determine a feature set for each of the second set of neighboring nodes.

7. The method of claim 6 wherein generating the target node embedding comprises:
aggregating the feature sets for each of the second set of neighboring nodes; and
generating the target node embedding using the aggregated feature sets for the second set of neighboring nodes.

8. The method of claim 1, wherein calculating the prediction score comprises:
determining a distance in a vector space for the source node embedding and the target node embedding; and
calculating the prediction score using the distance.

9. The method of claim 1, wherein calculating the prediction score comprises:
determining a distance in a vector space for the source node embedding and the target node embedding; and
calculating the prediction score using the distance.

10. The method of claim 1, wherein updating the weights of the graph neural network comprises:
determining a loss using the prediction score and a training prediction score; and
updating the weights of the graph neural network using the loss.

11. The method of claim 10, wherein determining the loss comprises:
determining the loss by applying a gradient descent loss function to the prediction score and the training prediction score.

12. A system for training a graph neural network comprising:
at least one memory device; and
a processing device, operatively coupled with the at least one memory device, to:
receive a plurality of content items for a user of an online system, wherein the plurality of content items comprises a plurality of skills;
generate an input graph using the plurality of content items, wherein the input graph comprises a plurality of nodes and a plurality of edges linking the plurality of nodes, wherein the plurality of nodes comprises a source node, a target node, and the plurality of skills;
sample the input graph using the source node and the plurality of skills to generate a first computational graph for the source node;
sample the input graph using the target node and the plurality of skills to generate a second computational graph for the target node;
generate a source node embedding by encoding the first computational graph;
generate a target node embedding by encoding the second computational graph;
calculate a prediction score by decoding the source node embedding and the target node embedding, wherein the prediction score comprises a predicted similarity between the source node and the target node based on the decoded source node embedding and the decoded target node embedding; and
updating weights of the graph neural network using the prediction score.

13. The system of claim 12, wherein the processing device is further to:
filter the plurality of skills for the plurality of content items.

14. The system of claim 12, wherein the plurality of skills includes one or more implied skills and wherein the processing device is further to:
generate the implied skill for the user using one or more content items of the plurality of content items, wherein the one or more content items are attributes of the user.

15. The system of claim 12, wherein the input graph further comprises a feature set for each of the plurality of nodes, wherein sampling the input graph using the source node comprises:
determining a first set of neighboring nodes of the plurality of nodes for the source node using the plurality of skills; and
sampling the first set of neighboring nodes to determine a feature set for each of the first set of neighboring nodes.

16. The system of claim 15, wherein generating the source node embedding comprises:
aggregating the feature sets for each of the first set of neighboring nodes; and
generating the source node embedding using the aggregated feature sets.

17. The system of claim 15, wherein the input graph further comprises a feature set for each of the plurality of nodes, wherein sampling the input graph using the target node comprises:
determining a second set of neighboring nodes of the plurality of nodes for the target node using the plurality of skills; and
sampling the second set of neighboring nodes to determine a feature set for each of the second set of neighboring nodes.

18. The system of claim 17, wherein generating the target node embedding comprises:
aggregating the feature sets for each of the second set of neighboring nodes; and
generating the target node embedding using the aggregated feature sets for the second set of neighboring nodes.

19. The system of claim 12, wherein calculating the prediction score comprises:
determining a distance in a vector space for the source node embedding and the target node embedding; and
calculating the prediction score using the distance.

20. A system for training a graph neural network comprising:
at least one memory device; and
a processing device, operatively coupled with the at least one memory device, to:
receive a plurality of content items for a user of an online system, wherein the plurality of content items comprises a plurality of skills;
filter the plurality of skills for the plurality of content items;
generate an input graph using the plurality of content items, wherein the input graph comprises a plurality of nodes and a plurality of edges linking the plurality of nodes, wherein the plurality of nodes comprises a source node, a target node, and the filtered plurality of skills;
sample the input graph using the source node and the filtered plurality of skills to generate a first computational graph for the source node;
sample the input graph using the target node and the filtered plurality of skills to generate a second computational graph for the target node;
generate a source node embedding by encoding the first computational graph;
generate a target node embedding by encoding the second computational graph;
calculate a prediction score by decoding the source node embedding and the target node embedding, wherein the prediction score comprises a predicted similarity between the source node and the target node based on the decoded source node embedding and the decoded target node embedding; and
update weights of the graph neural network using the prediction score.
